(19) United States
(12) Patent Application Publication
(10) Pub. No.: US 2024/0420134 A1
(43) Pub. Date: Dec. 19, 2024

(54) SYSTEMS AND METHODS FOR DYNAMIC TIME-BASED RESOURCE MANAGEMENT

(71) Applicant: Wells Fargo Bank, N.A., San Francisco, CA (US)

(72) Inventors: Young M. Yang, San Francisco, CA (US); Jenny Yee Tao, San Francisco, CA (US)

(73) Assignee: Wells Fargo Bank, N.A., San Francisco, CA (US)

(21) Appl. No.: 18/210,999

(22) Filed: Jun. 16, 2023

(51) Int. Cl. G06Q 20/40

(52) U.S. Cl. CPC G06Q 20/401

(57) ABSTRACT

A computing system includes a processor circuit that causes a processor to receive, from a user device, a request to enroll in a service, receive, from the user device, a request to link a first account with a second account, generate a third account, couple the third account with the first and second account, generate a unique identifier for the second account, assign the unique identifier to the second account, transmit, to a third party system, the unique identifier, receive, from the third party system, a resource transfer request associated with the second account including a transaction amount and the unique identifier, determine an available amount of resources of the first account, compare the available amount of resources of the first account with the transaction amount, cause a transfer of an amount of resources from the first account to the third account, and transmit, to the user device, a notification.

### TECHNICAL FIELD

The present disclosure relates to systems and methods for dynamic time-based resource management.

### BACKGROUND

Customers may use various payment methods, including credit accounts, in resource transfers. For example, a customer may use a line of credit to make a transaction and may transfer resources from a first account to a second account to settle the transaction at a later time. However, it may be difficult to efficiently manage such resource transfers. For example, in some instances, a first account may not have sufficient resources to settle one or more credit card bills. Therefore, computerized systems and methods to automatically transfer resources in real-time based on detected transactions and other factors may be desired.

### SUMMARY

At least one arrangement relates to a computing system of a provider institution. The computing system includes a network interface, a database structured to store a plurality of user profiles associated with a plurality of users, each of the plurality of users associated with the provider institution, and a processing circuit coupled to the network interface and the database, the at least one processing circuit comprising at least one processor and at least one memory, the at least one memory structured to store instructions that are executable to cause the at least one processor to: receive, via the network interface, from a user device associated with a user profile of the plurality of user profiles and communicably coupled to the computing system, a first request to enroll in a service; receive, via the network interface, from the user device, a second request to link a first account associated with the user profile with a second account; generate a third account responsive to receiving the first request; couple the third account with the first account and the second account; generate a unique identifier for the second account responsive to receiving the second request; assign the unique identifier to the second account; transmit, via the network interface, to a third party computing system communicably coupled to the computing system, the unique identifier; receive, via the network interface, from the third party computing system, a resource transfer request associated with the second account, the resource transfer request including a transaction amount and the unique identifier; determine an available amount of resources of the first account; compare the available amount of resources of the first account with the transaction amount; determine, based on the comparison, that the available amount of resources within the first account is less than the transaction amount; cause a transfer of an amount of resources from the first account to the third account, wherein the amount of resources transferred is less than the transaction amount; and transmit, via the network interface, to the user device, a notification indicating that resources within the first account are insufficient to satisfy the resource transfer request.

At least one arrangement relates to a computer-implemented method, comprising: receiving, by a computing system associated with a provider institution, from a user device communicably coupled to the computing system and associated with a user profile of a plurality of user profiles stored in a database of the computing system, a first request to enroll in a service; receiving, by the computing system, from the user device, a second request to link a first account associated with the user profile with a second account; generating, by the computing system, a third account responsive to receiving the first request; coupling, by the computing system, the third account with the first account and the second account; generating, by the computing system, a unique identifier for the second account responsive to receiving the second request; assigning, by the computing system, the unique identifier to the second account; transmitting, by the computing system, to a third party computing system communicably coupled to the computing system, the unique identifier; receiving, by the computing system, from the third party computing system, a resource transfer request associated with the second account, the resource transfer request including a transaction amount and the unique identifier; determining, by the computing system, an available amount of resources of the first account; comparing, by the computing system, the available amount of resources of the first account with the transaction amount; determining, by the computing system, based on the comparison, that the available amount of resources within the first account is less than the transaction amount; causing, by the computing system, a transfer of an amount of resources from the first account to the third account, wherein the amount of resources transferred is less than the transaction amount; and transmitting, by the computing system, to the user device, a notification indicating that resources within the first account are insufficient to satisfy the resource transfer request.

At least one arrangement relates to a non-transitory computer readable medium storing instructions that, when executed by at least one processor, cause the at least one processor to: receive, via a network interface, from a user device associated with a user profile of a plurality of user profiles of a provider institution, a first request to enroll in a service; receive, via the network interface, from the user device, a second request to link a first account associated with the user profile with a second account; generate a third account responsive to receiving the first request; couple the third account with the first account and the second account; generate a unique identifier for the second account responsive to receiving the second request; assign the unique identifier to the second account; transmit, via the network interface, to a third party computing system, the unique identifier; receive, via the network interface, from the third party computing system, a resource transfer request associated with the second account, the resource transfer request including a transaction amount and the unique identifier; determine an available amount of resources of the first account; compare the available amount of resources of the first account with the transaction amount; determine, based on the comparison, that the available amount of resources within the first account is less than the transaction amount; cause a transfer of an amount of resources from the first account to the third account, wherein the amount of resources transferred is less than the transaction amount; and transmit, via the network interface, to the user device, a notification indicating that resources within the first account are insufficient to satisfy the resource transfer request.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a system for providing and managing an automatic holding account, according to an example embodiment.

FIG. 2 is a flow diagram of a method of providing and managing an automatic holding account, according to an example embodiment.

FIGS. 3A-3H are example user interfaces presented to a user during a process of providing and managing an automatic holding account, according to an example embodiment.

### DETAILED DESCRIPTION

Referring generally to the Figures, systems and methods for managing dynamic time-based resources using a temporary account for credit transactions, such as credit card transactions, in an efficient and effective way are disclosed according to various embodiments herein. In some instances, the systems and methods described herein allow for a user of a provider institution to enroll in a temporary holding account service provided by a provider computing system and link one or more credit accounts and/or one or more demand deposit accounts. During enrollment or at a subsequent time, the systems and methods described herein may enable generation of a temporary holding account associated with the one or more demand deposit accounts for the user. The provider computing system may automatically effectuate a resource transfer (e.g., a funds transfer) between the one or more demand deposit accounts and the holding account of the user responsive to receiving an indication of a credit transaction, such as a request to initiate a credit card transaction. This indication/request may be masked as a dummy transaction (e.g., a not real transaction that is not processed), a push notification, a webhook, and so on. Thus, this indication/request transaction is separate from a typical transaction process. Beneficially, by implementing this separate indication/request transaction, the provider computing system may receive information regarding the credit transaction quicker and process this information in a more real-time manner than conventional methods and systems. As described herein, the provider computing system may automatically manage resources between the accounts based on predetermined established user settings including account limits (e.g., minimum amount requirements, overdraft fees, interest rates, etc.) and multiple credit card lines associated with the user. This enables an improved resource management system for the user, as described herein.

Beneficially, the systems and methods described herein may automatically manage resources between multiple accounts of a user based on predetermined established user settings thereby reducing a user's click path as compared to conventional techniques. For example, establishing settings regarding a prioritization of resources, which may be established during an enrollment process, may reduce the amount of user inputs necessary for enabling a resource transfer from a first account (e.g., a demand deposit account) to a second account (e.g., a credit account). Typically, a user may enroll in an auto-pay service to manage their credit account. The auto-pay service enables automatically paying their credit card balance periodically (e.g., monthly) from a designated account (e.g., a demand deposit account, such as a checking account). Alternatively, the user may need to log into their credit card account each month to manually cause a payment from a designated account to their credit card account. In the first scenario, the credit card account is not communicating with other credit card accounts and/or the user's designated account. In this way, the demand deposit account resources are automatically pulled even in potentially detrimental situations (e.g., reducing the funds amount to below a predefined limit). In the second scenario, computing power is needed to log into the credit card account, potentially log into the demand deposit account to check balance information to determine how much to pay to the credit card account, and then arrange the transfer. In this way and after the source payment account designation is defined, the backend systems need to communicate to enable the resource transfer from the designated demand deposit account to the credit account. Not only are these situations time-intensive on behalf of the user, but memory and processing requirements are utilized to operate in this conventional manner. Enhanced systems and methods are needed to effectively manage the resources of the source payment account (e.g., the demand deposit account) relative to one or more credit accounts of the user.

Technically and beneficially, the systems and methods described herein provide various technical solutions to the various problems and shortcomings of conventional resource transfer systems as alluded to above. For example, the systems and methods described herein operate in a non-conventional way by automatically managing account resources for multiple credit lines (e.g., credit card accounts, lines of credits such as a home equity line of credit, etc.) based on one or more predetermined settings, which provides the benefit of minimizing the notifications and/or messages required in order to perform an account management process by leveraging stored data associated with predetermined settings. This requires fewer resources and results in less network congestion than would be required through having to perform the process using more notifications. Furthermore, the systems and methods described herein operate in a non-conventional way by reducing a click path a user must take to manage multiple accounts, such as a demand deposit account and a holding account, thereby increasing processing power of conventional computing systems by reducing an amount of inputs into a graphical user interface to complete a resource transfer. Furthermore, the systems and methods described herein may automatically generate a temporary account and couple one or more credit accounts with the generated temporary account, which is of itself a non-conventional operation. For example, receiving duplicate transaction information associated with a credit account to enable setting aside resources in the temporary account (e.g., earmarking) in real-time, separate from a typical transaction process, is unconventional and not commonly understood in conventional techniques. Various other technical benefits and advantages are described in greater detail below.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

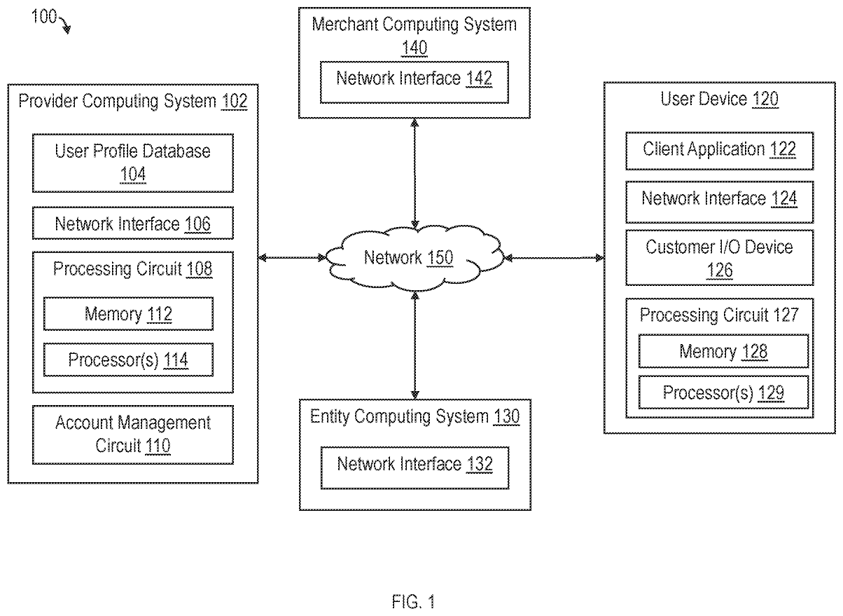

FIG. 1 is a diagram of a computing environment 100 for automatically holding and managing resources (e.g., funds) for credit card transactions, according to an example embodiment. As shown, the computing environment 100 includes one or more provider computing systems 102 associated with a provider (e.g., a financial institution), one or more user devices 120 associated with one or more users, one or more merchant computing systems 140, and/or one or more entity computing systems 130. (The entity computing system 130 and/or the merchant computing system 140 are sometimes referred to as a third party computing system herein). The provider computing system(s) 102, the user device(s) 120, and/or the entity computing system(s) 130 are in communication with each other and are connected by a network 150, which may include one or more of the Internet, cellular network, Wi-Fi, Wi-Max, a proprietary banking network, or any other type of wired or wireless network or a combination of wired and wireless networks. As described herein, the computing environment 100 may be used to manage credit transactions using one or more holding accounts.

For clarity, the following description will refer to a provider computing system 102, a merchant computing system 140, and an entity computing system 130. However, it will be understood that the following description of any of these devices and computing systems will be similarly applicable to any additional corresponding devices and computing systems (e.g., additional provider computing systems 102, merchant computing systems 140, and/or entity computing systems 130) and that, in some embodiments, the computing environment 100 may include a plurality of any of the described devices and systems.

The provider computing system 102 is owned by, associated with, or otherwise operated by a provider institution (e.g., a bank or other financial institution) that maintains one or more accounts held by various customers (e.g., the customer associated with the user device 120), such as demand deposit accounts, credit card accounts, reserve (e.g., holding) accounts that are described in more detail below, receivables accounts, and so on. In some instances, the provider computing system 102, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider computing system 102 may be or may include various other devices communicably coupled thereto, such as, for example, desktop or laptop computers (e.g., tablet computers), smartphones, wearable devices (e.g., smartwatches), and/or other suitable devices.

In some embodiments, the provider computing system 102 includes a user profile database 104, a network interface 106, and at least one processing circuit 108 having at least one memory 112 and one or more processors 114. The provider computing system 102 may include at least one account management circuit 110. In some instances, the network interface 106 includes, for example, hardware and/or program logic that connects the provider computing system 102 to the network 150. The network interface 106 facilitates secure communications between the provider computing system 102 and each of the user device(s) 120 and entity computing system(s) 130. The network interface 106 also facilitates communication with other entities, such as other banks, settlement systems, and so on. The network interface 106 further includes user interface program logic configured to generate and present web pages to users accessing the provider computing system 102 over the network 150.

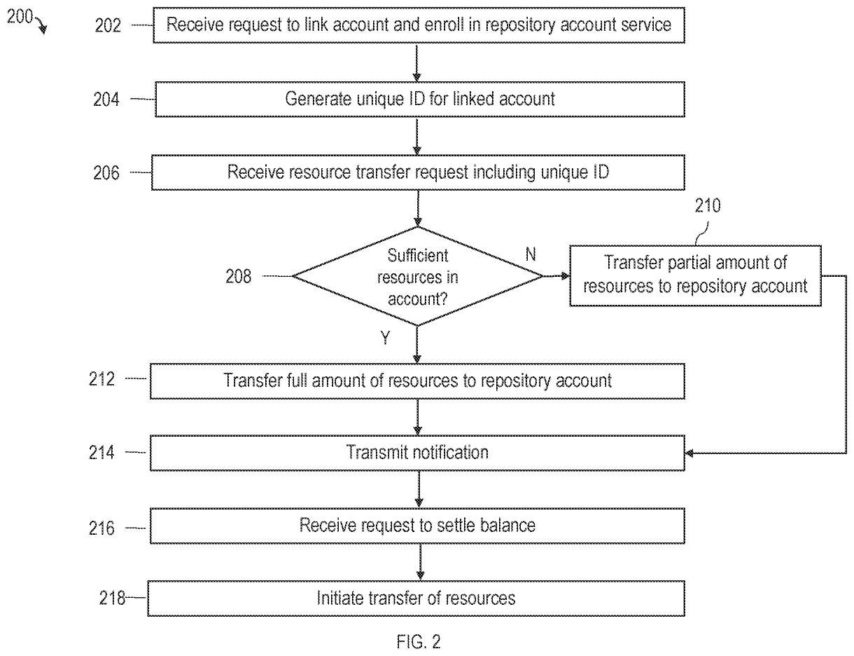

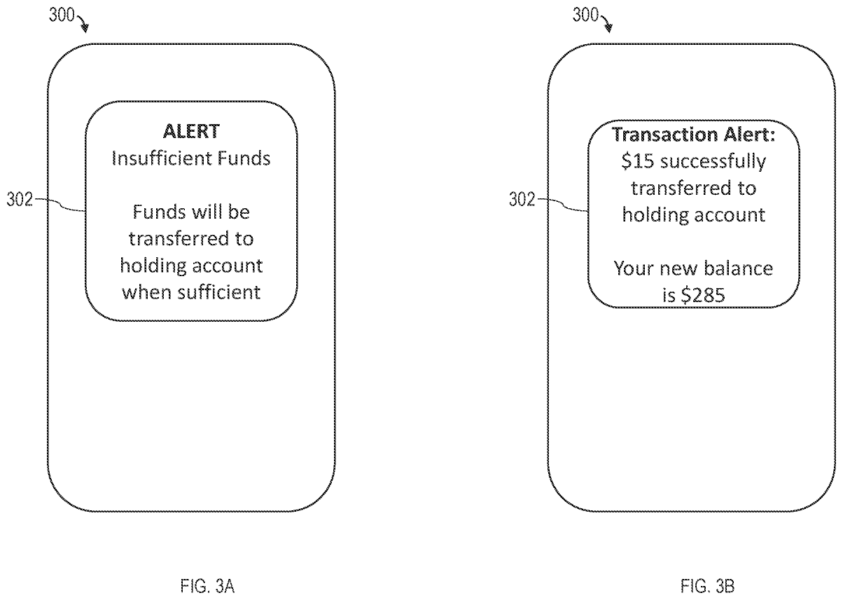

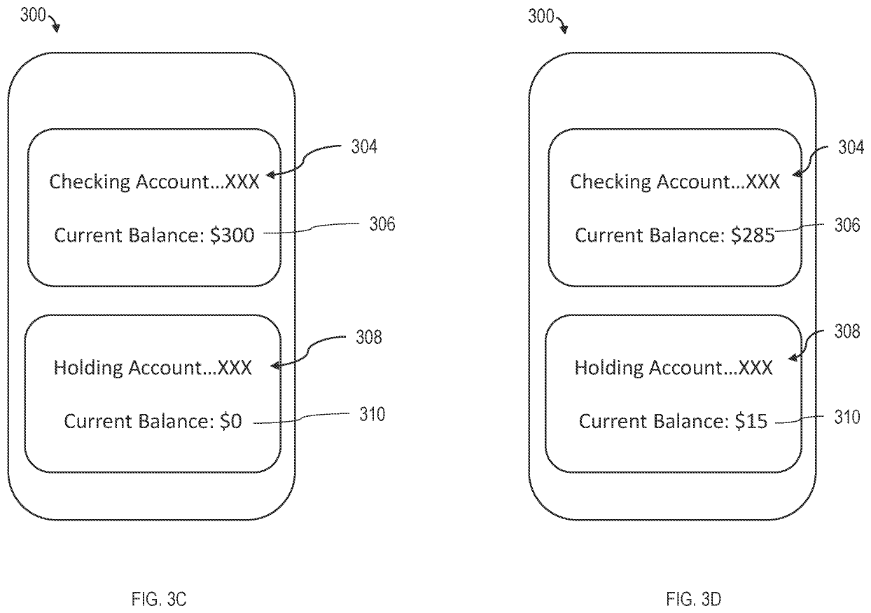

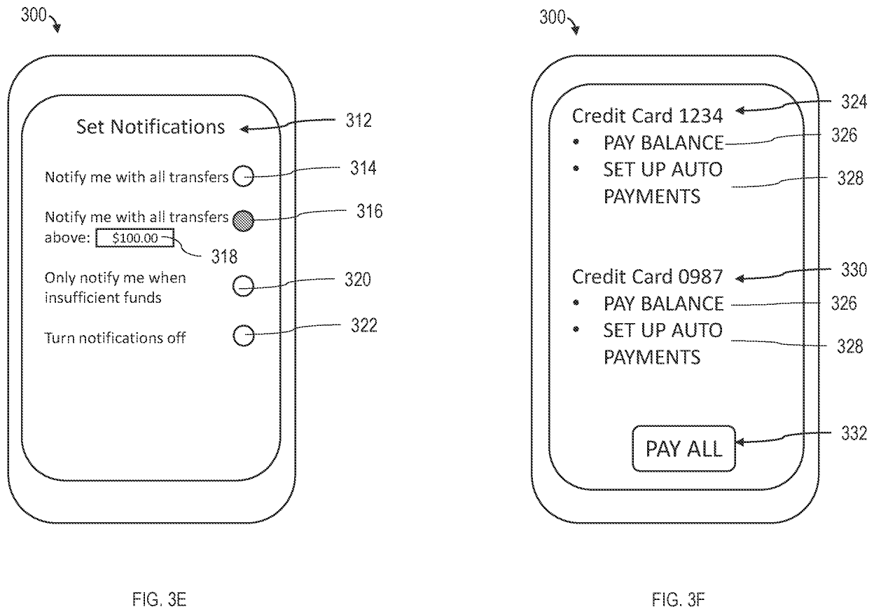

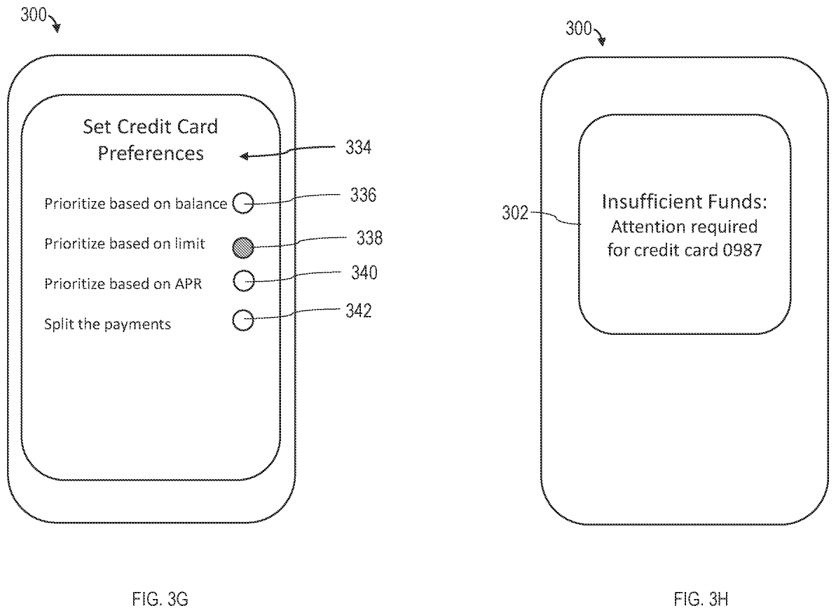

The user profile database 104 is structured or configured to retrievably store user information associated with the one or more users, who may be associated with, own, and/or manage one or more user devices 120. In some instances, the user information may include a name, a phone number, an e-mail address, a physical address, account information (e.g., account number), notification settings, credit accounts, credit limits, etc. of the user. As described herein, the provider computing system 102 may be configured to receive and store the user information into personalized user profiles of the user profile database 104 during an enrollment and/or log-in process of a customer. The account management circuit 110 is structured or configured to perform a variety of functionalities or operations to enable and monitor various customer activities (e.g., managing credit transactions, credit accounts, holding accounts, etc.) in connection with user profile data stored within the user profile database 104. For example, the account management circuit 110 may be configured to monitor and/or pull data stored within the user profile database 104 from one or more user profiles associated with the user device 120. The account management circuit 110 may be structured or configured to receive information from the one or more entity computing systems 130 and/or merchant computing systems 140, manage an amount of funds between various accounts of the user profile associated with the user device 120, manage and transmit notifications to the user device 120, and/or a variety of other services associated with and/or provided by the financial institution, as described in greater detail with reference to FIGS. 2-3H.

The user device 120 is owned, operated, controlled, managed, and/or otherwise associated with a customer (e.g., a customer of the provider or financial institution). In some embodiments, the user device 120 may be or may include, for example, a desktop or laptop computer (e.g., a tablet computer), a smartphone, a wearable device (e.g., a smartwatch), a personal digital assistant, and/or any other suitable computing device. In the example shown, the user device 120 is structured as a mobile computing device, namely a smartphone.

In some embodiments, the user device 120 includes one or more I/O devices 126, a network interface 124, and one or more client applications 122. While the term “I/O” is used, it should be understood that the I/O devices 126 may be input-only devices, output-only devices, and/or a combination of input and output devices. In some instances, the I/O devices 126 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 126 further include one or more user interfaces (devices or components that interface with the customer), which may include one or more biometric sensors (such as a fingerprint reader, a heart monitor that detects cardiovascular signals, face scanner, an iris scanner, etc.).

The network interface 124 includes, for example, hardware and/or program logic and various devices (e.g., transceivers, etc.) that connect the user device 120 to the network 150. The network interface 124 facilitates secure communications between the user device 120 and each of the provider computing system 102, the merchant computing system 140, and/or the entity computing system 130. The network interface 124 also facilitates communication with other entities, such as other banks, settlement systems, and so on.

The user device 120 includes at least one processing circuit 127 having at least one memory 128 and at least one processor 129. The user device 120 stores in computer memory 128, and executes (“runs”) using one or more processors 129, various client applications, such as an Internet browser presenting websites, text messaging applications (e.g., for sending MMS or SMS to the provider computing system 102, the merchant computing system 140, and/or the entity computing system 130), and/or applications provided or authorized by entities implementing or administering any of the computing systems in computing environment 100.

In the example shown, the user device 120 includes a provider institution client application 122. The provider institution client application 122 may be provided by and at least partly supported by the provider computing system 102. In this regard, the client application 122 may be coupled to the provider computing system 102 may enable the customer to perform various customer activities (e.g., account management, tracking, etc.) and/or perform various transactions (e.g., transferring money between one or more accounts, paying various bills, etc.) associated with one or more customer accounts of the customer held at the provider associated with the provider computing system 102 (e.g., account opening and closing operations, fund transfers, etc.). In the example shown, the provider institution client application 122 may be a mobile banking application that enables various banking and resource management functionalities provided and supported by the provider computing system 102. In some instances, the client application 122 provided by the provider computing system 102 may additionally be coupled to the entity computing system 130 and/or the merchant computing system 140 (e.g., via one or more application programming interfaces (APIs), webhooks, and/or software development kits (SDKs)) to integrate one or more features or services provided by the entity computing system 130 and/or the merchant computing system 140. In some instances, the client application 122 may be provided as a web-based feature or application.

The entity computing system 130 is controlled by, managed by, owned by, and/or otherwise associated with an entity (e.g., an account provider external to the provider associated with the provider computing system 102) that is configured to transmit information to the provider computing system 102. Although not specifically shown, it will be appreciated that the entity computing system 130 may include a network interface 132, various databases (e.g., similar to the user profile database 104), and/or processing circuits comprising processor(s) and memory device(s) in the same or similar manner to the other components of computing environment 100. As described herein, the entity may be one or more providers of an account capable of initiating a transaction. In the example shown, the entity computing system 130 is associated with a credit provider, such as a credit company, and as such may be referred to herein as a credit entity computing system 130. It should be appreciated that while only one entity is depicted, the system may include a plurality of entities.

The merchant computing system 140 is controlled by, managed by, owned by, and/or otherwise associated with a merchant that is configured to transmit information to the provider computing system 102. Although not specifically shown, it will be appreciated that the merchant computing system 140 may include a network interface 142, various databases (e.g., similar to the user profile database 104), and/or processor(s) in the same or similar manner to the other components of computing environment 100. Further, it should be appreciated that while only one merchant is depicted, the system may include a plurality of merchants.

The merchant may operate one or more brick and mortar locations. In some embodiments, the merchant may provide e-commerce shopping platforms. The merchant may offer goods and/or services for sales via any of these channels. As such, the merchant computing system 140 may include or be coupled to one or more point-of-sale (POS) devices and/or other merchant terminals for enabling transactions for the one or more goods and/or services.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 2, a flow diagram of a method 200 for dynamic time-based resource management for credit transactions, such as credit card transactions, is shown, according to an example embodiment. Various operations of the method 200 may be conducted by the computing environment 100 and particularly parts thereof (e.g., the provider computing system 102, the user device 120, the entity computing system 130, and/or the merchant computing system 140).

As a brief overview, at process 202, the provider computing system 102 (e.g., the account management circuit 110) receives a request to link one or more accounts (e.g., first and second accounts) and/or a request to enroll in a repository account (e.g., third account) service, particularly a holding account service. At process 204, the account management circuit 110 generates a unique ID for the one or more linked accounts. At process 206, the account management circuit 110 receives a resource transfer request including the generated unique ID. At process 208, the account management circuit 110 determines if there are sufficient resources (e.g., funds) in an account associated with a user. If the account management circuit 110 determines that there are insufficient funds, the account management circuit 110 proceeds to process 210 and transfers a partial amount of funds to a generated temporary holding account. If the account management circuit 110 determines that there are sufficient funds, the account management circuit 110 proceeds to process 212 and transfers a full amount of funds to the holding account. At process 214, the account management circuit 110 transmits a notification to the user device 120. At process 216, the account management circuit 110 receives a request to settle a balance. At process 218, the account management circuit 110 initiates a transfer of funds.

In greater detail, at process 202, the provider computing system 102 (e.g., the account management circuit 110) may be configured to receive a request to link one or more first accounts (e.g., demand deposit accounts associated with or external to a user profile stored in the user profile database 104) with one or more second accounts (e.g., credit card accounts) and/or a request to enroll in a temporary third (e.g., holding) account service (also referred to herein as a repository account service). For example, the account management circuit 110 may be configured receive an input from a user device 120 (e.g., via the provider institution client application 122) indicating a user wishes to enroll in the temporary holding account service of the provider institution. As part of enrollment, the user, via the provider institution client application 122, may link or associate one or more payment accounts (first account(s)) with one or more credit accounts (second account(s)). As described herein, the third, repository or temporary holding account (e.g., a reserve account, an account designated for one particular purpose) is generated as part of the service for storing funds associated with credit card transactions.

The account management circuit 110 may be configured to generate one or more of the holding accounts responsive to receiving the request to enroll in the service and maintain information associated with the holding account in a user profile associated with the user device 120 stored in the user profile database 104. For example, the account management circuit 110 may be configured to create the repository account (e.g., a storage account) that is earmarked for funds associated with credit transactions. The repository holding account may not be linked with a debit card or other card. For example, the account management circuit 110 may be configured to generate one or more withdrawal rules associated with the repository holding account (e.g., withdrawals are only allowed for credit transactions). The account management circuit 110 may be configured to generate an account number associated with the repository holding account such that the client application 122 may display the holding account as a separate account (e.g., separate from a demand deposit account or credit account). In some implementations, the client application 122 may be configured to display the one or more linked credit accounts associated with the repository holding account on a display of the user device 120. The user profile may include information of at least one demand deposit account (e.g., a checking account, a savings account, a money market account, etc.) held at the provider institution and associated with the user of the user device 120 such that the holding account can be linked with the demand deposit account. The demand deposit account may be existing and/or generated with the holding account (e.g., at the same provider institution). In some implementations, the account management circuit 110 may be configured to receive one or more inputs (e.g., a routing number, an account number, etc.) to the provider institution client application 122 executing on the user device 120 to link an external demand deposit account (e.g., external to the provider institution) with the temporary holding account. As described in greater detail herein, the account management circuit 110 may be configured to automatically transfer funds from the one or more first (demand deposit) accounts to the holding account (or one or more holding accounts if multiple are generated) based on an initial transaction request that is separate from a typical transaction process (e.g., part of a dummy transaction, a webhook, a push notification, etc.).

In some implementations, the account management circuit 110 may be configured to couple the one or more first payment (demand deposit) accounts with the one or more second accounts (credit account(s)) and with the one or more generated third (repository) accounts. For example, the account management circuit 110 may be configured to link the one or more first (demand deposit) accounts with the one or more second (credit) accounts. The account management circuit 110 may be configured to associate the generated third (repository holding) account with the one or more first (demand deposit) accounts to couple each of the accounts together. The account management circuit 110 may be configured to directly link the one or more credit accounts with the generated repository holding account. For example, and regarding credit accounts at the provider institution, the account management circuit 110 may be configured to automatically detect and link a credit account of the provider institution associated with the provider computing system 102 (e.g., stored in the user profile database 104) with the demand deposit account and/or holding account (e.g., responsive to receiving an input to the user device 120 indicating to link the accounts). For example, the account management circuit 110 may be configured to query the user profile database 104 for one or more credit accounts associated with a user profile. Responsive to receiving a response to the query indicating at least one credit account is associated with the user profile, the account management circuit 110 may be configured to transmit a prompt to the user device 120 (e.g., via the provider institution client application 122) asking if the user wishes to link the one or more credit accounts with their demand deposit account(s). Responsive to receiving an input to the prompt, the account management circuit 110 may be configured to link the one or more credit accounts and demand deposit accounts.

In some implementations, the account management circuit 110 may be configured to receive information (e.g., a routing number, an account number, a credit card number, etc.) of a credit account held external to the provider institution (e.g., a credit account held at a third party entity, such as the entity computing system 130). For example, the account management circuit 110 may be configured to receive an account number, name, and/or other information of a credit account associated with an entity computing system 130 via one or more user inputs to the provider institution client application 122. The account management circuit 110 may be configured to authorize the account and/or exchange data with the entity computing system 130 in real-time to confirm the account. For example, the account management circuit 110 may be configured to transmit, via an API call, to a third party computing system (e.g., the entity computing system 130), a request to link to the repository account enrollment service. The account management circuit 110 may be configured to receive, as a response to the API call, a reply from the entity computing system 130 to complete enrollment of the credit account.

At process 204, the account management circuit 110 may be configured to generate or establish a unique ID, webhook, or other identifier, such as a numeric, alpha, and/or alphanumeric value for each linked external credit or demand deposit account (e.g., accounts associated with the entity computing system 130), assign, tag and/or associate the external credit or demand deposit account with the unique ID and/or transmit the unique ID to the entity computing system 130. For example, the account management circuit 110 may be configured to generate a first unique ID for a first linked credit card (e.g., ABC123456??!!), a second unique ID for a second linked credit card (e.g., ABD12345@12), and so on. For example, each generated unique ID may be specific to a linked credit account. The account management circuit 110 may be configured to generate the specific unique ID for each credit account responsive to the credit account being linked with the one or more demand deposit accounts. The account management circuit 110 may be configured to assign the generated unique ID to the respective credit card account and/or the account management circuit 110 may be configured to transmit the generated unique ID to the entity computing system 130 (e.g., the credit account provider) such that each transaction associated with the credit maintained by that separate will be tagged with the unique ID. Generating and assigning a specific unique ID to one or more credit accounts enables identification and association of the credit account as being part of the temporary holding account service, which enables improved resource management and reduces inputs necessary for the account management circuit 110 to determine an identity (e.g., user profile) associated with a credit account.

When a transaction associated with the linked credit account occurs, the account management circuit 110 may be configured to receive the unique ID, webhook, and/or other identifier of the credit transaction in real time and separate from a typical transaction process from a third party computing system (e.g., the entity computing system 130 and/or from the merchant computing system 140), as described herein.

At process 206, the provider computing system 102 (e.g., the account management circuit 110) receives a real-time resource transfer (e.g., transaction) request from a third computing system (e.g., the entity computing system 130 and/or the merchant computing system 140) including an amount of the transaction and/or the assigned unique ID of the second account associated with the transaction. The transaction request may be at least partially separate from a typical credit card transaction process (e.g., structured as a notification, dummy transaction, and/or other requests described in greater detail herein). In particular and in one embodiment, an indication of a transaction with a credit account is received that is separate from an actual credit transaction. In this way, the provider computing system 102 receives at least partially duplicative information associated with the transaction. For example, the account management circuit 110 may be configured to receive a transaction request structured as part of a webhook or similar tool originating from the entity computing system 130 and/or from the merchant computing system 140 (e.g., via the network 150) simultaneously with or in addition to a typical transaction authentication process. In particular, the indication of the transaction is received before notification of the actual transaction for process per normal transaction processing methodologies. In some implementations, the account management circuit 110 may be configured to receive the request as part of a credit card purchase authorization process (e.g., as a standard four party credit card transaction between a customer, a merchant, an issuing bank and an acquiring bank). For example, the account management circuit 110 may be configured to receive the request when a user of the user device 120 initiates a transaction with the merchant computing system 140, such as at a point-of-sale (POS) device or other device associated with the merchant computing system 140. In some implementations, the account management circuit 110 may be configured to receive the request from the entity computing system 130 (e.g., a provider associated with the credit account). For example, the account management circuit 110 may be configured to receive the request from the entity computing system 130 when the credit card/account used to make the transaction is external to the provider computing system 102. In some implementations, the account management circuit 110 may be configured to receive the transaction request associated with a mobile wallet transaction. In some implementations, the account management circuit 110 may be configured to receive the transaction request associated with a physical card transaction and/or an e-commerce transaction.

In some implementations, the account management circuit 110 may be configured to receive, with the request, the unique ID or other identifier associated with the credit account (e.g., credit card) used to make the transaction and linked with the holding account and/or demand deposit account. For example, the account management circuit 110 may be configured to automatically receive a unique ID associated with a linked credit account from the merchant computing system 140 (e.g., when the credit account is associated with the provider computing system 102) and/or from the entity computing system 130 (e.g., when the credit account is associated with a provider external to the provider computing system 102). In some instances (e.g., transactions with a physical credit card, e-commerce transactions, etc.), the account management circuit 110 may be configured to receive a notification from the credit entity computing system 130 (e.g., based on the stored unique ID) when the tagged/associated credit card is used. The notification may include various transaction information including, but not limited to, the amount of the transaction and the unique ID. Therefore, the unique ID and notification allows quick transaction communications that are separate from a normal, standard transaction processing request. In some instances (e.g., with mobile wallet transactions), the linked credit account may transmit, via the established link, transaction information to the client application 122 in real-time as the transaction occurs, even if the transaction has not been processed yet. Therefore, the established link between the credit account and the client application 122 allows for receiving transaction information instantaneously or near instantaneously. Accordingly, the generated and assigned unique IDs facilitate allowing one or more third party systems (e.g., the entity computing system 130 and/or the merchant computing system 140) to transmit transaction information in real-time that would not otherwise be transmitted to enable real-time resource management.

In some instances, the account management circuit 110 and/or the client application 122 may be configured to render a prompt on the user device 120 to receive transaction information responsive to determining the user device 120 is located near a known merchant. For example, the account management circuit 110 may be configured to store a plurality of geolocations associated with known merchants (e.g., merchant computing systems 140). In such instances, the account management circuit 110 may be configured to pull a geolocation of the user device 120 responsive to receiving (e.g., from an entity computing system 130) a notification indicating a transaction has occurred. The account management circuit 110 may be configured to compare the received geolocation of the user device 120 with geolocations of known merchants to determine the user device 120 is located at or near a known merchant. Responsive to determining the geolocation, the account management circuit 110 and/or the client application 122 may be configured to render a prompt on the user device 120 asking for details regarding the transaction (e.g., a confirmation of the transaction, an amount of the transaction, a credit account associated with the transaction, etc.)

In some implementations, the account management circuit 110 may be configured to receive the unique ID packaged as a data payload along with an amount of the transaction as part of a notification and/or as a dummy transaction (e.g., in real-time, prior to the authentication and processing of the transaction). For example, even when the transaction is not yet processed, the account management circuit 110 may be configured to receive information associated with the transaction in real-time via a notification or other protocol that is independent from a typical transaction authorization request (e.g., a notification that is not transmitted through standard credit processing channels). In some implementations, the transaction request may be structured as a hypertext transfer protocol (HTTP) POST request to a destination uniform resource location (URL) associated with the provider institution client application 122. The POST request may indicate an identifier of the credit account (e.g., the unique ID) and the amount of the transaction.

At process 208, the account management circuit 110 determines an available amount of resources (e.g., to determine if there are sufficient funds) in a source, payment account (i.e., a first account) of the user profile stored in the user profile database 104. The first account may be a demand deposit account, such as a checking account, a savings account, and/or another type of demand deposit account. The first account may be maintained by the provider that operates, owns, is associated with, or otherwise manages the provider computing system. The account management circuit 110 may be configured to determine a current balance of the demand deposit account and compare the balance with the amount of funds of the transaction request to determine if the funds within the demand deposit account can satisfy the transaction request. For example, the account management circuit 110 may be configured to determine the demand deposit account has $5000, which is greater than a transaction in the amount of $50 and therefore the amount in the demand deposit account can satisfy the request. As another example, the account management circuit 110 may be configured to determine the demand deposit account has $100, which is less than a transaction in the amount of $250 and therefore the amount in the demand deposit account is insufficient to satisfy the request.

In some implementations, the account management circuit 110 may be configured to determine a current balance of a plurality of demand deposit accounts associated with the user profile. For example, the account management circuit 110 may be configured to compare the transaction amount with at least one of the plurality of demand deposit accounts of the user to determine if a combination of funds between the plurality of demand deposit accounts is sufficient to satisfy the transaction request. By way of example, the account management circuit 110 may be configured to transmit, via an API call, a request for one or more balances to one or more external demand deposit accounts (e.g., a first demand deposit account and/or a second demand deposit account held at the entity computing system 130). Responsive to receiving a reply to the API call, the account management circuit 110 may be configured to determine the first demand deposit account has a first balance and the second demand deposit account gas a second balance. The account management circuit 110 may be configured to determine if a combination of funds between the first and second balance are sufficient to satisfy the transaction request.

If the account management circuit 110 determines, based on the comparison, that there are insufficient funds for the transaction amount associated with the resource transfer request, the account management circuit 110 proceeds to process 210 and transfers a partial amount of resources (e.g., funds) to the generated repository or holding account associated with the user profile and first, source account (i.e., a demand deposit account). For example, the account management circuit 110 may be configured to determine, based on the comparison between the demand deposit account balance and the transaction amount, that the demand deposit account balance and/or the plurality of balances of the plurality of demand deposit accounts (e.g., associated with the provider computing system 102 and/or external to the provider computing system 102) are less than the transaction amount. In some implementations, the account management circuit 110 may be configured to determine there are insufficient funds in the demand deposit account even if the demand deposit account balance is equal to or greater than the transaction amount. For example, the account management circuit 110 may be configured to determine one or more predefined minimum balance rules apply to the demand deposit account (e.g., a minimum balance required in demand deposit account to avoid fees) based on information stored in the user profile. The account management circuit 110 may be configured to add the minimum balance amount to the transaction amount prior to and/or simultaneously with comparing the demand deposit account balance to determine if the demand deposit account balance is sufficient to satisfy the transaction amount without falling below the minimum balance. The account management circuit 110 may be configured to prioritize the minimum balance over satisfying the full amount of funds. In some implementations, the account management circuit 110 may be configured to continuously and/or cyclically determine the balance of the demand deposit account to detect if any deposits have been made to transfer resources to the holding account.

The account management circuit 110 may be configured to initiate a transfer of an amount of resources (e.g., funds) that is a partial amount of the transaction amount. For example, the account management circuit 110 may be configured to initiate an amount of funds in the range of 0% to 99% of the transaction amount from the demand deposit account to the holding account associated with the demand deposit account that is stored in the user profile database 104. In some implementations, the account management circuit 110 may be configured to cause the initiation of the funds transfer instantaneously or nearly instantaneously with receiving the transaction request. In some implementations, the account management circuit 110 may be configured to cause the initiation of the funds transfer within a predetermined period of time of receiving the transaction request (e.g., 30 minutes, 1 hour, 1 day, etc.). In some implementations, the account management circuit 110 may be configured to transmit a notification to the user device 120 regarding the insufficient funds and/or transfer by proceeding to process 214, as described in greater detail herein.

If the account management circuit 110 determines that there are sufficient funds, the account management circuit 110 proceeds to process 212 and transfers a full amount of resources (e.g., funds) to the generated repository, holding account. For example, the account management circuit 110 may be configured to determine that at least one current balance of at least one demand deposit account is greater than or equal to the transaction amount and/or greater than or equal to the transaction amount and the minimum balance requirement of the demand deposit account. The account management circuit 110 may be configured to initiate a transfer of funds in the full amount of the transaction amount from the at least one demand deposit account to the holding account. In some implementations, the account management circuit 110 may be configured to transfer partial amounts of the transaction amount from each of a plurality of demand deposit accounts. For example, the account management circuit 110 may be configured to initiate a transfer of funds equal to a first value or percentage (e.g., 20%, 30%, 50%, etc.) of the transaction amount from a first demand deposit account of one or more demand deposit accounts of the user to the holding account and initiate a transfer of funds equal to a second value or percentage (e.g., 20%, 30%, 50%, etc.) of the transaction amount from a second demand deposit account to the holding account such that the holding account receives an amount of funds corresponding to the transaction amount. Thus, the holding account may hold or store funds sufficient to pay for a credit transaction(s), such as one or more credit card bills, while the demand deposit account can reflect an actual balance (e.g., including funds deducted to pay for the credit card transaction) prior to the bill actually being paid. This helps users see in real or nearly real-time their actual account balance.

At process 214, the account management circuit 110 and/or the client application 122 transmits at least one notification to the user device 120. For example, the client application 122 may be configured to generate a notification and cause the notification to render on a display of the user device 120. FIGS. 3A and 3B depict example user interfaces 300 having a notification 302 displayed on the user interface 300. In some implementations, the account management circuit 110 may be configured to transmit the one or more notifications 302 to the user device 120 responsive to the demand deposit account(s) not having sufficient funds and/or responsive to a partial or full amount of funds being transferred from at least one demand deposit account to the holding account. The notification 302 may include various information regarding the transfer of funds between the demand deposit account and the holding account. For example, the one or more notifications 302 may include an indication of insufficient funds (e.g., as shown in FIG. 3A), an indication that the account management circuit 110 may be configured to continuously check the demand deposit account balance for a deposit of funds to initiate a transfer when funds become sufficient (e.g., as shown in FIG. 3A), and/or an indication that some amount of funds (e.g., partial or in full) has been transferred to the holding account, as shown in FIG. 3B. For example, the notification may include an indication that a remaining amount of resources is scheduled for transferring when the available amount of resources within the demand deposit is sufficient. The notification 302 may include various additional or alternative information including, but not limited to, an indication of the demand deposit account number used to transfer funds, an indication of a current balance in the demand deposit account and/or the holding account, an indication of the time date, and/or location of the transaction, and/or various additional information.

In some implementations, the account management circuit 110 may be configured to generate and provide a user interface that reflects a real balance of the demand deposit account(s) and/or of the holding account. For example, FIG. 3C depicts a user interface 300 before the account management circuit 110 receives the transaction request and FIG. 3D depicts the user interface 300 after the account management circuit 110 causes a funds transfer from the demand deposit account to the holding account. As shown in FIG. 3C, the user interface 300 may include an indication of the demand deposit account 304 (e.g., account name, account number, etc.), a current balance 306 of the demand deposit account 304, an indication of the holding account 308 (e.g., account name, account number, etc.), and/or a current balance 310 of the holding account 308. By way of example, before the account management circuit 110 receives a transaction request, the current balance 306 of the demand deposit account 304 may be a first value (e.g., $300) and the current balance 310 of the holding account 308 may be a second value (e.g., $0). Responsive to receiving the transaction request (e.g., in the amount of $15), the account management circuit 110 may be configured to determine funds in the demand deposit account 304 are sufficient and cause a transfer of the amount of funds of the transaction request (e.g., $15) from the demand deposit account 304 to the holding account 308. As depicted in FIG. 3D, the account management circuit 110 may be configured to dynamically update the current balance 306 of the demand deposit account 304 and/or the current balance 310 of the holding account 308 to reflect to the transfer of funds responsive to receiving the transaction request and/or initiating the transfer.

In some implementations, the account management circuit 110 may be configured to transmit the one or more notifications to the user device 120 according to various notification settings established for the holding account. For example, during enrollment of a user into the holding account, the account management circuit 110 may be configured to generate and provide a user interface 300 for setting notifications, as depicted in FIG. 3E. As shown in FIG. 3E, the user interface 300 may include a notifications settings list 312 including various customizable notification settings. The list 312 may include a plurality of selectable features. For example, the list 312 may include an all transfers selectable feature 314. Responsive to receiving an input to the all transfers selectable feature 314, the account management circuit 110 may be configured to transmit at least one notification to the user device 120 for each transaction request and/or transfer of funds from the demand deposit account(s) to the holding account, regardless of an amount of the transaction request and/or whether the demand deposit account(s) has sufficient funds. The list 312 may include a transaction amount selectable feature 316. Responsive to receiving an input to the transaction amount selectable feature 316, the account management circuit 110 may be configured to transmit at least one notification to the user device 120 for each transaction request and/or transfer of funds from the demand deposit account(s) to the holding account for transaction requests above a predetermined amount. For example, the list 312 may include at least one transaction amount input 318. Responsive to receiving an input to the transaction amount input 318, the account management circuit 110 may be configured to set the predetermined amount. The list 312 may include an insufficient funds selectable feature 320. Responsive to receiving an input to the insufficient funds selectable feature 320, the account management circuit 110 may be configured to transmit at least one notification to the user device 120 for each transaction request and/or transfer of funds from the demand deposit account(s) to the holding account when the demand deposit account(s) does not have sufficient funds to satisfy the transaction request. The list 312 may include an off selectable feature 322. Responsive to receiving an input to the off selectable feature 322, the account management circuit 110 may be configured to not transmit any notifications to the user device 120 when an amount of funds is transferred between accounts. The list 312 may include various additional or alternative selectable features that configure notification settings.

At process 216, the account management circuit 110 receives a request to settle a balance. For example, the account management circuit 110 may be configured to receive a request to pay a credit card balance by initiating a transfer of funds from the holding account to pay the balance. In some implementations, the account management circuit 110 may be configured to receive the request to pay the balance from the user device 120. For example, the account management circuit 110 may be configured to generate and provide a user interface 300 including one or more credit lines (e.g., credit card accounts), as depicted in FIG. 3F. As shown in FIG. 3F, the user interface 300 may include at least one indication of a credit card account 324 (e.g., a name of the account, a card number, etc.). The user interface 300 may include one or more selectable features associated with the credit card account 324. For example, the user interface 300 may include a pay balance selectable feature 326. Responsive to receiving an input to the pay balance selectable feature 326, the account management circuit 110 may be configured to initiate a transfer of resources (e.g., funds), as described herein. The user interface 300 may include an automatic payments selectable feature 328. Responsive to receiving an input to the automatic payments selectable feature 328, the account management circuit 110 may be configured to schedule a future transfer of funds to pay future balances at a specified time and/or date over a predetermined period of time (e.g., the first day of every month for one year).

In some implementations, a user profile may be associated with a plurality of credit card lines. As depicted in FIG. 3F, the account management circuit 110 may be configured to render one or more of the credit card accounts on the user interface 300. For example, the user interface 300 may include an indication of a second credit card account 330. In some implementations, the user interface 300 may include each of the plurality of credit card accounts on one display (e.g., as shown in FIG. 3F). In some implementations, the user interface 300 may include each of the credit card accounts on separate displays. Each of the one or more credit card accounts may be associated with a provider of the provider computing system 102.

At process 218, the account management circuit 110 initiates a transfer of resources. For example, the account management circuit 110 may be configured to initiate a transfer of funds out of the holding account responsive to the account management circuit 110 receiving the request to pay a balance (e.g., via an input to one or more of the pay balance selectable features 326 and/or automatic payments selectable features 328). In other words, the account management circuit 110 may be configured to facilitate settling a credit card balance using the funds reserved in the holding account equal to the transaction request(s).

In some implementations, the account management circuit 110 may be configured to receive one or more requests to pay a plurality of balances. For example, the account management circuit 110 may be configured to receive a first user input to the pay balance selectable feature 326 associated with a first credit account 324 and a second user input to the pay balance selectable feature 326 associated with a second credit account 330, each within a predetermined window of time (e.g., 30 seconds, 5 minutes, 1 day, etc.). As another example, the user interface 300 may include a pay all selectable feature 332 such that the account management circuit 110 may be configured to receive a user input to the pay all selectable feature 332 indicating to settle all credit card balances. Responsive to receiving the request(s) to pay the one or more balances, the account management circuit 110 may be configured to compare the balance of the generated repository, holding account with the current balances of each of the plurality of credit accounts. If the account management circuit 110 determines the amount of funds of the holding account is sufficient to satisfy the plurality of balances, the account management circuit 110 may be configured to initiate one or more transfer of funds from the holding account to settle each of the credit card balances.

If the account management circuit 110 determines the amount of funds in the holding account is not sufficient to satisfy each of the balances, the account management circuit 110 may be configured to compare information of each of the credit accounts (e.g., credit card accounts) to automatically prioritize and effectuate a payment to one of the credit card accounts and/or between the credit card accounts. For example, the account management circuit 110 may be configured to compare a first balance, a first credit limit, and/or a first annual percentage rate of a first credit card account (e.g., account 324) with a second balance, a second credit limit, and/or a second annual percentage rate of a second credit card account (e.g., account 330). In some implementations, the account management circuit 110 may be configured to prioritize the payment of the balances based on the comparison. For example, in some implementations, the account management circuit 110 may be configured to transfer funds from the holding account to settle the credit card account with a higher balance. In some implementations, the account management circuit 110 may be configured to prioritize a greater percentage of funds from the holding account towards the settlement of the credit card account with the higher balance than the lower balance. In some implementations, the account management circuit 110 may be configured to transfer funds from the holding account to settle the credit card account with a lower credit card limit. In some implementations, the account management circuit 110 may be configured to prioritize a greater percentage of funds from the holding account towards the settlement of the credit card account with the lower credit card limit than the higher limit. In some implementations, the account management circuit 110 may be configured to transfer funds from the holding account to settle the credit card account with a greater annual percentage rate (APR). In some implementations, the account management circuit 110 may be configured to prioritize a greater percentage of funds from the holding account towards the settlement of the credit card account with the greater APR than the lesser APR. In some implementations, the account management circuit 110 may be configured to prioritize a greater percentage of funds from the holding account towards the settlement of the credit card account with a closer (e.g., sooner) due date.

In some implementations, the account management circuit 110 may be configured to automatically prioritize the balances of one or more credit accounts based on one or more predetermined settings determined and/or selected via one or more inputs to the client application 122. For example, as depicted in FIG. 3G, the account management circuit 110 and/or the client application 122 may be configured to generate and provide a user interface 300 including a credit card preferences settings section 334 (e.g., during the enrollment process of the holding account and/or responsive to receiving an input to an automatic payments selectable feature 328). As shown in FIG. 3G, the credit card preferences settings section 334 may include a plurality of selectable features to customize automatic prioritization of credit card payments. For example, the section 334 may include a balance prioritization selectable feature 336. Responsive to receiving an input to the balance prioritization selectable feature 336, the account management circuit 110 and/or the client application 122 may be configured to prioritize funds within the holding account towards a credit card account with a higher balance (e.g., when funds are insufficient to satisfy a plurality of balances). The section 334 may include a limit prioritization selectable feature 338. Responsive to receiving an input to the limit prioritization selectable feature 338, the account management circuit 110 and/or the client application 122 may be configured to prioritize funds within the holding account towards a credit card account with a lower credit limit when funds are insufficient to satisfy a plurality of balances. The section 334 may include an APR prioritization selectable feature 340. Responsive to receiving an input to the APR prioritization selectable feature 340, the account management circuit 110 and/or the client application 122 may be configured to prioritize funds within the holding account towards a credit card account with a higher annual percentage rate when funds are insufficient to satisfy a plurality of balances. The section 334 may include a split selectable feature 342. Responsive to receiving an input to the split selectable feature 342, the account management circuit 110 and/or the client application 122 may be configured to split the funds within the holding account evenly towards a plurality of credit card accounts when funds are insufficient to satisfy the plurality of balances. In some implementations, the section 334 may include a selectable feature to prioritize the funds within the holding account towards a balance of a credit card account with a sooner due date. In some implementations, the account management circuit 110 and/or the client application 122 may be configured to store the selected settings in the user profile database 104. In some implementations, the account management circuit 110 and/or the client application 122 may be configured to transmit a notification to the user device 120 indicating that funds in the holding account were insufficient to pay one or more balances, as depicted in FIG. 3H.

Various non-limiting illustrative examples will now be described. As a first example, a user may make a first purchase using a first credit card at a first merchant (e.g., in the amount of $15). In real-time with the purchase, the account management circuit 110 may be configured to receive various information (e.g., amount, unique ID, etc.) regarding the purchase (e.g., a transaction request) from a third party system (e.g., the credit entity computing system 130 or the merchant computing system 140). For example, as described herein, the account management circuit 110 may be configured to receive the purchase/transaction information structured as a dummy transaction, notification (e.g., as part of a webhook), etc. from the third party system. Responsive to receiving the transaction request originating from the first merchant in the amount of $15, the account management circuit 110 may be configured to parse a demand deposit account associated with the user (e.g., by querying the user profile database 104 and/or by transmitting an API call to the entity computing system 130) and determine funds within the account are sufficient (e.g., $200). The account management circuit 110 may be configured to transfer $15 from the demand deposit account to a holding account of the user and notify the user device (e.g., user device 120) of the transfer. The user may make a second purchase using a second credit card at a second merchant (e.g., in the amount of $200). Responsive to receiving a transaction request originating from the second merchant in the amount of $200, the account management circuit 110 may be configured to parse the demand deposit account associated with the user and determine funds within the account are insufficient (e.g., $185). The account management circuit 110 may be configured to transmit a notification to a user device 120 of the user to alert the user of insufficient funds. For example, the client application 122 may be configured to generate a graphical user interface and populate the graphical user interface on the user device 120 using information stored in the provider computing system 102 (e.g., from the account management circuit 110). The account management circuit 110 may be configured to transfer $185 from the demand deposit account to the holding account. The account management circuit 110 may be configured to receive an input from the user device 120 indicating to pay all credit card bills. Responsive to receiving the input, the account management circuit 110 may be configured to determine predetermined prioritization settings established by the user during enrollment indicating to prioritize the credit card settlements based on a credit card limit. The account management circuit 110 may be configured to determine, based on information stored in a user profile associated with the user, that the credit limit of the first credit card is $1000 and a credit limit of the second card is $4000. Responsive to determining the first credit card includes a lower credit limit, the account management circuit 110 may be configured to initiate a transfer of funds of $15 from the holding account to settle the first credit card balance. The account management circuit 110 may be configured to initiate a transfer of the remaining amount of funds (e.g., $185) from the holding account to partially settle the second credit card balance.

As a second example, the account management circuit 110 may be configured to automatically manage refund transactions from a merchant (e.g., the merchant computing system 140) and/or from a credit provider (e.g., the credit entity computing system 130). For example, in some instances, one or more credit accounts associated with the user profile may be configured to receive a credit initiated from the merchant computing system 140 and/or the entity computing system 130 during a credit card transaction refund process. In some instances, the account management circuit 110 may be configured to detect the refund responsive to receiving a user input to the user device 120 (e.g., to a selectable feature indicating a refund has been received). In some instances, the account management circuit 110 and/or the client application 122 may be configured to automatically receive the refund and/or a notification regarding the refund from the merchant computing system 140 and/or the entity computing system 130 (e.g., structured as a notification, a dummy transaction, etc.). Responsive to receiving the refunded credit, the account management circuit 110 may be configured to automatically transfer an amount of funds equal to the amount of refunded credit from the holding account to at least one demand deposit account. In some implementations, the account management circuit 110 may be configured to transfer an amount of funds equal to the amount of refunded credit from the holding account to the demand deposit account responsive to receiving a user input. For example, responsive to detecting the refunded payment amount, the account management circuit 110 may be configured to transmit a notification to the user device 120 indicating the refund and asking if a user would like funds associated with the original payment to be moved from the holding account back to the demand deposit account (e.g., using a selectable feature with the notification). Responsive to receiving an input to the selectable feature indicating the user would like the funds transferred, the account management circuit 110 may be configured to transfer the amount of funds equal to the amount of refunded credit from the holding account to the original demand deposit account. In some implementations, responsive to a user input to the user device 120, the account management circuit 110 may be configured to leave the funds within the holding account.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system of a provider institution, the computing system comprising:
a network interface;
a database structured to store a plurality of user profiles associated with a plurality of users, each of the plurality of users associated with the provider institution; and
at least one processing circuit coupled to the network interface and the database, the at least one processing circuit comprising at least one processor and at least one memory, the at least one memory structured to store instructions that are executable to cause the at least one processor to:
receive, via the network interface, from a user device associated with a user profile of the plurality of user profiles and communicably coupled to the computing system, a first request to enroll in a service;
receive, via the network interface, from the user device, a second request to link a first account associated with the user profile with a second account;
generate a third account responsive to receiving the first request;
couple the third account with the first account and the second account;
generate a unique identifier for the second account responsive to receiving the second request;
assign the unique identifier to the second account;
transmit, via the network interface, to a third party computing system communicably coupled to the computing system, the unique identifier;
receive, via the network interface, from the third party computing system, a resource transfer request associated with the second account, the resource transfer request including a transaction amount and the unique identifier;
determine an available amount of resources of the first account;
compare the available amount of resources of the first account with the transaction amount;
determine, based on the comparison, that the available amount of resources within the first account is less than the transaction amount;
cause a transfer of an amount of resources from the first account to the third account, wherein the amount of resources transferred is less than the transaction amount; and
transmit, via the network interface, to the user device, a notification indicating that resources within the first account are insufficient to satisfy the resource transfer request.

2. The computing system of claim 1, wherein the second account is associated with the user profile and the instructions further cause the at least one processor to:
query the database for the second account;
transmit, via the network interface, to the user device, a prompt to link the second account with the first account;
receive, via the network interface, a manual input to the prompt; and
link the first account and the second account responsive to receiving the manual input to the prompt.

3. The computing system of claim 1, wherein the second account is held at a third party associated with the third party computing system external to the provider institution and the instructions further cause the at least one processor to:
receive, via the network interface and via at least one input to the user device, account information associated with the second account;
transmit, via a third party application programming interface (API), a request to the third party computing system to couple the second account with the third account;
receive, via the third party API, from the third party computing system, a reply to the request; and
couple the second account with the third account responsive to receiving the reply.

4. The computing system of claim 1, wherein the resource transfer request is structured as a real-time notification transmitted from the third party computing system.

5. The computing system of claim 1, wherein the notification further includes an indication that a remaining amount of resources is scheduled for transferring when the available amount of resources within the first account is equal to or greater than a difference between the transaction amount and the amount of resources transferred.

6. The computing system of claim 1, wherein the instructions further cause the at least one processor to:
receive, via the network interface, from the user device, a request to pay a balance of the second account; and
initiate a withdrawal of resources from the third account responsive to receiving the request to pay the balance.

7. The computing system of claim 1, wherein the instructions further cause the at least one processor to:
receive, via the network interface, from the third party computing system, a credit amount of resources associated with a refund of the second account; and
initiate a transfer of resources from the third account to the first account based on the credit amount of resources.

8. A computer-implemented method comprising:
receiving, by a computing system associated with a provider institution, from a user device communicably coupled to the computing system and associated with a user profile of a plurality of user profiles stored in a database of the computing system, a first request to enroll in a service;
receiving, by the computing system, from the user device, a second request to link a first account associated with the user profile with a second account;
generating, by the computing system, a third account responsive to receiving the first request;
coupling, by the computing system, the third account with the first account and the second account;
generating, by the computing system, a unique identifier for the second account responsive to receiving the second request;
assigning, by the computing system, the unique identifier to the second account;
transmitting, by the computing system, to a third party computing system communicably coupled to the computing system, the unique identifier;
receiving, by the computing system, from the third party computing system, a resource transfer request associated with the second account, the resource transfer request including a transaction amount and the unique identifier;
determining, by the computing system, an available amount of resources of the first account;
comparing, by the computing system, the available amount of resources of the first account with the transaction amount;
determining, by the computing system, based on the comparison, that the available amount of resources within the first account is less than the transaction amount;
causing, by the computing system, a transfer of an amount of resources from the first account to the third account, wherein the amount of resources transferred is less than the transaction amount; and
transmitting, by the computing system, to the user device, a notification indicating that resources within the first account are insufficient to satisfy the resource transfer request.

9. The method of claim 8, wherein the second account is associated with the user profile and the method further comprises:
querying, by the computing system, the database for the second account;
transmitting, by the computing system, to the user device, a prompt to link the second account with the first account;
receiving, by the computing system, a manual input to the prompt; and
linking, by the computing system, the first account and the second account responsive to receiving the manual input to the prompt.

10. The method of claim 8, wherein the second account is held at a third party associated with the third party computing system external to the provider institution and the method further comprises:
receiving, by the computing system, via at least one input to the user device, account information associated with the second account;
transmitting, by the computing system, via a third party application programming interface (API), a request to the third party computing system to couple the second account with the third account;
receiving, by the computing system, via the third party API, from the third party computing system, a reply to the request; and
coupling, by the computing system, the second account with the third account responsive to receiving the reply.

11. The method of claim 8, wherein the resource transfer request is structured as a real-time notification transmitted from the third party computing system.

12. The method of claim 8, wherein the notification further includes an indication that a remaining amount of resources is scheduled for transferring when the available amount of resources within the first account is equal to or greater than a difference between the transaction amount and the amount of resources transferred.

13. The method of claim 8, further comprising:
receiving, by the computing system, from the user device, a request to pay a balance of the second account; and
initiating, by the computing system, a withdrawal of resources from the third account responsive to receiving the request to pay the balance.

14. The method of claim 8, further comprising:
receiving, by the computing system, from the third party computing system, a credit amount of resources associated with a refund of the second account; and
initiating, by the computing system, a transfer of resources from the third account to the first account based on the credit amount of resources.

15. A non-transitory computer readable medium storing instructions that, when executed by at least one processor, cause the at least one processor to:
receive, via a network interface, from a user device associated with a user profile of a plurality of user profiles of a provider institution, a first request to enroll in a service;
receive, via the network interface, from the user device, a second request to link a first account associated with the user profile with a second account;
generate a third account responsive to receiving the first request;
couple the third account with the first account and the second account;
generate a unique identifier for the second account responsive to receiving the second request;
assign the unique identifier to the second account;
transmit, via the network interface, to a third party computing system, the unique identifier;
receive, via the network interface, from the third party computing system, a resource transfer request associated with the second account, the resource transfer request including a transaction amount and the unique identifier;
determine an available amount of resources of the first account;
compare the available amount of resources of the first account with the transaction amount;
determine, based on the comparison, that the available amount of resources within the first account is less than the transaction amount;
cause a transfer of an amount of resources from the first account to the third account, wherein the amount of resources transferred is less than the transaction amount; and
transmit, via the network interface, to the user device, a notification indicating that resources within the first account are insufficient to satisfy the resource transfer request.

16. The non-transitory computer readable medium of claim 15, wherein the second account is associated with the user profile and the instructions further cause the at least one processor to:
query a database for the second account;
transmit, via the network interface, to the user device, a prompt to link the second account with the first account;
receive, via the network interface, a manual input to the prompt; and
link the first account and the second account responsive to receiving the manual input to the prompt.

17. The non-transitory computer readable medium of claim 15, wherein the second account is held at a third party associated with the third party computing system external to the provider institution and the instructions further cause the at least one processor to:
receive, via the network interface and via at least one input to the user device, account information associated with the second account;
transmit, via a third party application programming interface (API), a request to the third party computing system to couple the second account with the third account;
receive, via the third party API, from the third party computing system, a reply to the request; and
couple the second account with the third account responsive to receiving the reply.

18. The non-transitory computer readable medium of claim 15, wherein the resource transfer request is structured as a real-time notification transmitted from the third party computing system.

19. The non-transitory computer readable medium of claim 15, wherein the notification further includes an indication that a remaining amount of resources is scheduled for transferring when the available amount of resources within the first account is equal to or greater than a difference between the transaction amount and the amount of resources transferred.

20. The non-transitory computer readable medium of claim 15, wherein the instructions further cause the at least one processor to:
receive, via the network interface, from the user device, a request to pay a balance of the second account; and
initiate a withdrawal of resources from the third account responsive to receiving the request to pay the balance.
